(19) United States
(12) Patent Application Publication
(10) Pub. No.: US 2005/0257041 A1
(43) Pub. Date: Nov. 17, 2005

(54) Method and apparatus for remote computer reboot

(76) Inventors: Cory Wallenstein, Colts Neck, NJ (US); Kevin Joseph Menard JR., Leicester, MA (US)

Correspondence Address: LAW OFFICE OF BRETT N. DORNY, 321 CHURCH STREET, NORTHBOROUGH, MA, 01532, US

(21) Appl. No.: 11/101,854

(22) Filed: Apr. 8, 2005

Related U.S. Application Data
(60) Provisional application No. 60/571,297, filed on May 14, 2004.

(51) Int. Cl. G06F 9/00

(52) U.S. Cl. 713/2

(57) ABSTRACT

A remote reboot device allows unattended computer systems to be rebooted or restarted from a remote location. The remote reboot device uses the reset pins on a logic board of a computer system to effectuate a reboot. The remote reboot device includes a network interface for secure communication over a network. A user performs a login procedure to set up a secure communication with the remote reboot device and then selects one or more server to reboot. The remote reboot device sends appropriate signals to the reset pins to perform the reboot operation. Multiple computer systems can be controlled with a single remote reboot device. Alternatively, the remote reboot device may be attached to the power control pins on the logic board of the computer system and use an appropriate signaling sequence to reboot the system.

### CROSS REFERENCES

This application claims priority to U.S. Provisional Application No. 60/571,297 entitled Method And Apparatus For Computer Reboot, filed on May 14, 2004.

### BACKGROUND OF THE INVENTION

1. Field of the Invention

The present invention relates to control of unattended computers from a remote location. More particularly, it relates to a remote system for restarting a computer, such as a server, through a network.

2. Discussion of Related Art

Computer systems such as network servers, automated teller machines, and kiosks have long been plagued by software malfunctions, unauthorized access, and destructive authorized usage, often preventing the computer systems from operating normally. The inability of a computer system to operate normally results in system downtime, lost revenue, and additional maintenance expenses. The duration of the downtime is directly related to the extent of the damage induced. Remote computer systems, for which maintenance and support personnel are not on-site, are the most prone to the effects of downtime. Traditionally, a system administrator is required to physically travel to the location of the remote computer system to diagnose the situation and implement a solution to restore normal operation of the system.

In many cases, the simplest procedure to restore normal operation is to reboot the computer system, returning it to a system start up state. A system reboot can be generated either in software or in hardware. A software reboot is preferable since it allows the system to provide an orderly shutdown of any functioning programs and processes before restarting the computer. However, if a computer system is frozen, such that the computer system does not respond to a software reboot command, a hardware system reboot is the only recourse available. A hardware system reboot can be performed in one of two manners. The least sophisticated process is to disconnect the computer's power cable from the source of power to the system. This shuts the computer system down completely. Then, power can be restored and the system restarted A more sophisticated process performs a hardware reboot without removing the computer's power cable from the source of power.

Many of today's computer systems include hardware for performing a system reboot. A reset switch located on the chassis of the computer system connects to the motherboard or logic board of the computer system. When the switch is activated, the computer system restarts. The switch is connected to the motherboard through a pair of “reset” pins and performs a reboot by shorting the two reset pins.

Both power cycling and use of a reset switch require the operator to be physically present at the location of the computer systems. Since an increasing number of systems are located in an unattended location, rebooting the system is an inconvenient and time consuming task. As long as the computer system remains operational, most of the required maintenance services can be performed from a remote location. However, when the computer system stops responding to the remote location, a hardware reboot is required to get the system operating again.

Some external devices have been developed to restart a computer system from a remote location. Such devices are connected to the power source of the computer system. The devices further include a processor for communicating with the remote location, through a network. Upon receipt of a signal from the remote location, the device cycles the power to the computer system. However, this method of AC power cycling from a remote location presents a number of critical shortcomings.

A computer system that has its power removed will immediately turn off, but many computers will not turn back on once power is restored until a power switch is physically pressed. As a result many administrators are forced to improvise yet another solution to ensure the computer system will start back up when power is reapplied to it. Such a system not only reduces the servers' versatility, but is an extremely time consuming and tedious task.

Additionally, the process of cycling the power to a server poses a risk of damaging several sensitive components. As such, many system administrators refuse to install traditional remote reboot devices for fear of damaging their critical equipment. For example, hard disk drives that are active when a power cycle occurs are susceptible to physical damage from the internal components scratching the fragile disk platters, possibly resulting in a loss of data. Power supply units that regulate incoming power are susceptible to damage due to surge conditions during a power cycle. Such damage incurred during a remote power cycle at best results in additional downtime for the server and costs incurred during component replacement, and at worst results in data loss in the event of a hard disk drive failure.

U.S. Published patent application No. 2004/0093516, published on May 13, 2004, illustrates a system for remotely controlling equipment, such as computer systems. The system includes action modules for physically acting upon equipment. With this system, a signal from a remote location causes the device to physically press a button, such as the power switch or the reset switch on a computer system. However, operation of this system is difficult, since the robotic systems must be properly placed and wired in order to operate the buttons.

### SUMMARY OF THE INVENTION

A remotely operable device operates to assert the reset pins on a computer processing board, allowing a computer system to be rebooted from a location remote from where the computer system actually resides. According to an aspect of the invention, the remotely operable device can selectively reboot multiple computer systems. According to another aspect of the invention, a secure communication mechanism is used to remotely operate the device to ensure that computer systems are only rebooted by authorized persons. According to another aspect of the invention, the remotely operable device is connected to a network and is operable from any location on the network According to another aspect of the invention, the network includes a global network According to another aspect of the invention, the secure communication mechanism includes a login and authentication procedure. According to another aspect of the invention, the secure communication mechanism includes a secure socket layer (SSL) session. According to another aspect of the invention, the secure communication mechanism includes a secure shell (SSH) session.

According to another aspect of the invention, a multiplexer is connected between the remotely operable device and the reset pins of the computer processing board. The multiplexer is further connected to the reset switch of the computer system such that the system can be rebooted with either the remotely operable device or the reset switch

A method for remotely rebooting a computer system includes a secure communication from a first location to a second location, providing a signal from the second location to the reset pins of the computer system to cause a reboot operation According to another aspect of the invention, the secure communication includes a login and authentication procedure. According to another aspect of the invention, the secure communication includes a secure socket layer (SSL) session According to another aspect of the invention, the secure communication mechanism includes a secure shell (SSH) session According to another aspect of the invention, the secure communication occurs over a computer network.

According to another aspect of the invention, a remotely operable device is connected to the power pins of a computer system which does not have reset pins. The remotely operable device performs a reboot option to short the power pins in accordance with a predetermined pattern to cause the computer system power to shut off and turn back on According to another aspect of the invention, the remotely operable device is connectable to different types of computer systems, including connections to reset pins and power pins in different computer systems.

### BRIEF DESCRIPTION OF THE DRAWINGS

FIG. 1 is a block diagram of a remotely operable reboot device according to an embodiment of the present invention.

FIG. 2 is a flow diagram of operation of a remotely operable reboot device according to an embodiment of the present invention.

FIG. 3 is a user interface for remotely rebooting a computer system according to an embodiment of the present invention.

FIG. 4 is a block diagram of connections between a remotely operable reboot device and a computer system according to an embodiment of the present invention.

FIG. 5 is a block diagram of a remotely operable reboot device according to another embodiment of the present invention.

### DETAILED DESCRIPTION

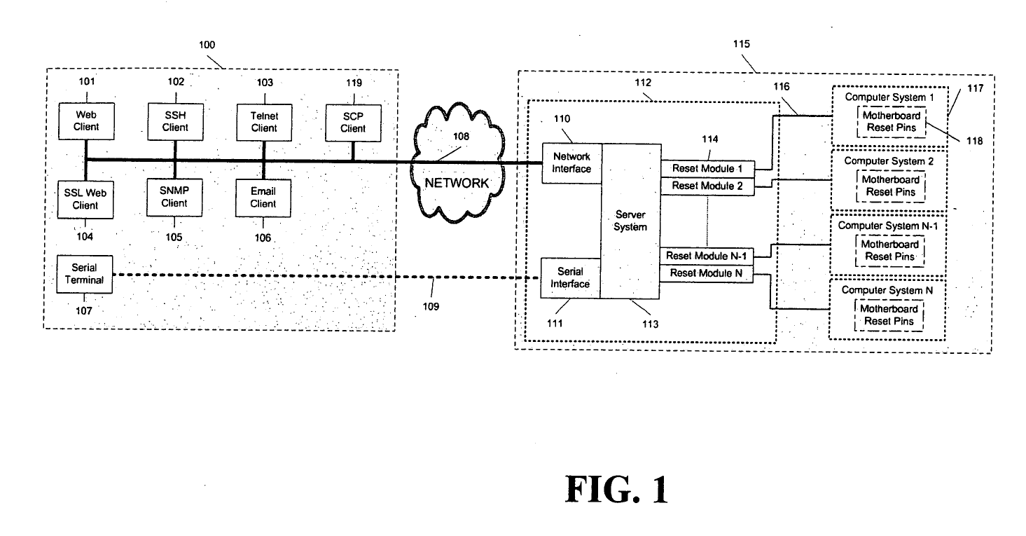

According to the present invention, a computer system can be rebooted remotely using the reset pins on the computer processing board A device that reboots the computer system by making use of the reset pins already available on the computer system's main logic board poses little risk of a power surge to the computer system, since such a device is restarting the computer system in a manner consistent with the computer system's design. Most computer system logic boards make this functionality available in the form of a set of pins to which a reset button is connected. FIG. 1 illustrates a remote reboot system according to an embodiment of the present invention. The remote reboot system includes a remote reboot device 112. The remote reboot device 112 is positioned with one or more computer systems 117 at a first location 115. The computer systems 117 may be complete systems, each including a processor, monitor, keyboard, mouse, display, disk drives, etc. Alternatively, the computer systems 117 may each simply include a processor and associated memory. Preferably, the computer systems are server machines. In order to operate with the present invention, each of the computer systems 1 17 must include a motherboard including reset pins 118. By shorting the reset pins 118 on a computer system 117, the computer system 117 begins a reboot process.

The remote reboot device 112 includes a server system 113 responsible for performing the operations of the remote reboot device 112. The server system 113 may include a processor and associated memory for storing a program operable on the processor to perform the desired functions. Alternatively, the server system 113 may be implemented as a programmed general purpose computer, a special purpose computer, a programmed chip, an ASIC, etc.

The remote reboot device 112 includes a plurality of reset modules 114 connected to the server system 113. Each of the reset modules 114 is connected by appropriate wiring 116 to the reset pins 118 of one of the computer systems 117. According to an embodiment of the invention, the wiring 116 consists of a pair of copper wires. The wiring 116 further includes a terminal connector (not shown) for connecting the wires to the reset pins. With a pair of copper wires, the terminal connector would connect one wire to each of the two reset pins. The reset modules 114 are designed to provide a short circuit to the corresponding reset pins 118 upon receipt of a signal from the server system 113. Any number of reset modules can be included within the remote reboot device 112 to accommodate any number of computer systems 117. According to an embodiment of the invention, eight reset modules.

The remote reboot device 112 further includes one or more interfaces for communicating with a remote location. According to an embodiment of the invention, the interface includes a network interface 110 for connection to a network. The network may include a local area network, wide area network, or global network, such as the Internet 108. The network interface 110 may be of any known type, such as an Ethernet port. The server system 113 would include appropriate programming for communicating through the network interface 110 to the network 108. Although FIG. 1 illustrates a wired connection between the network interface 110 and the network 108, other types of connections, such as infrared, RF or other wireless connections, could be used. A serial interface 111 may also be used for connecting to the remote reboot device.

The remote reboot device is controllable from a second location 100 spaced from the first location 115 where the computer systems 117 are located The locations may be separated by a small distance, such as different rooms in a building, or by greater distances, such as between buildings or even between countries or continents. Preferably, the locations would not be co-located. One of the advantages of the present invention is that an operator does not have to go to the location of a malfunctioning computer system 117 to perform a reboot operation. On the other hand, a serial terminal 107 could be connected to the serial interface 111 and positioned within the room housing the computer systems 117. This would allow an operator to use the remote reboot device to easily reboot a computer system 117 using the remote reboot device, if he or she happened to be at that location. [00251 A variety of client interfaces can be used at the remote location 100 to operate the remote reboot device 112. While FIG. 1 illustrates various client interfaces, not all would necessarily be present or available at the remote location 100. A single client interface is needed to communicate with the remote reboot device. Client interfaces could include a web client 101, a telnet client 103, a Simple Network Management Protocol (SNMP) client 105, an email client 106, a Secure Shell (SSH) 102, a Secure Copy (SCP) 119, and a Secure Sockets Layer (SSL) web client 104. Preferably, a secure and encoded form of communication is used over the network 108. Unauthorized users are prevented from intercepting authentication credentials and other general data included in the communication and from interfering with operation of the computer systems 117 through the remote reboot device.

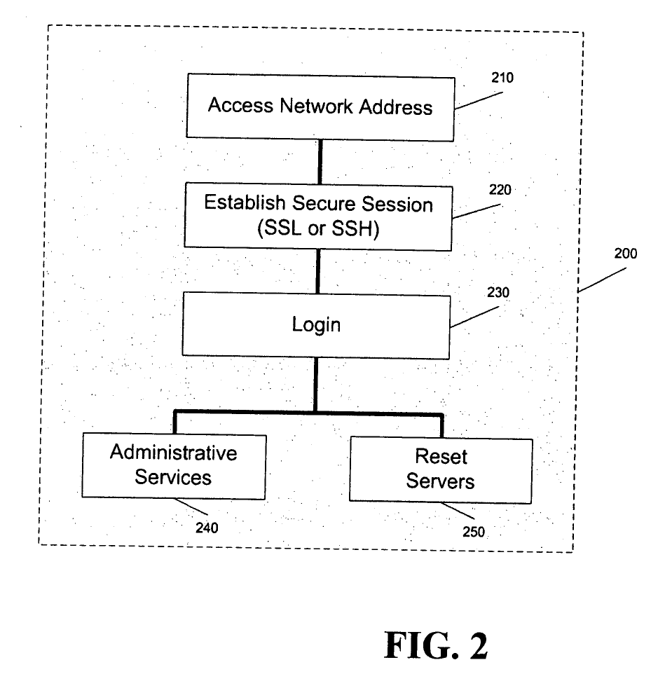

FIG. 2 illustrates the operation 200 of the remote reboot device 112 according to an embodiment of the invention. At step 210, a user accesses the network address of the remote reboot device 112 from a client at the remote location 100. The mechanisms for accessing the remote reboot device 112 would depend upon the nature of the device and the type of client being used for the interface. According to one embodiment, a HTTP request is made to the network address of the remote reboot device for accessing the device. Preferably, a secure connection is created for communications with the device 112. A SSL session or SSH session is established at step 220 using conventional processes to create the secure connection. Once the session is established, the device 112 returns a login screen. The login screen allows the user to enter an ID and a password. The ID and password are checked with those of authorized users stored in the memory of the remote reboot device 112. Other forms of authentication and secure communications may be used. For example, an email message may be sent to the remote reboot device. For security purposes, the email may be encrypted and may include authentication information. An ID and password may also be linked with one or more specific IP address to provide increased security for the system.

According to an embodiment of the invention, the process for establishing a connection with the remote reboot device 112 is as follows:
1. Client specifies WebReboot address, either in a browser or in an SSH client.
2. At the IP/ARP level, the address is located and the packets are routed.
3. At the TCP level, a socket connection is established.
4. At the network application level, either SSL/HTTP or SSH, a secure connection is negotiated.
5. At the remote reboot device 112 level, after a secure connection is established, the user is prompted for login credentials and verified as an authorized user.

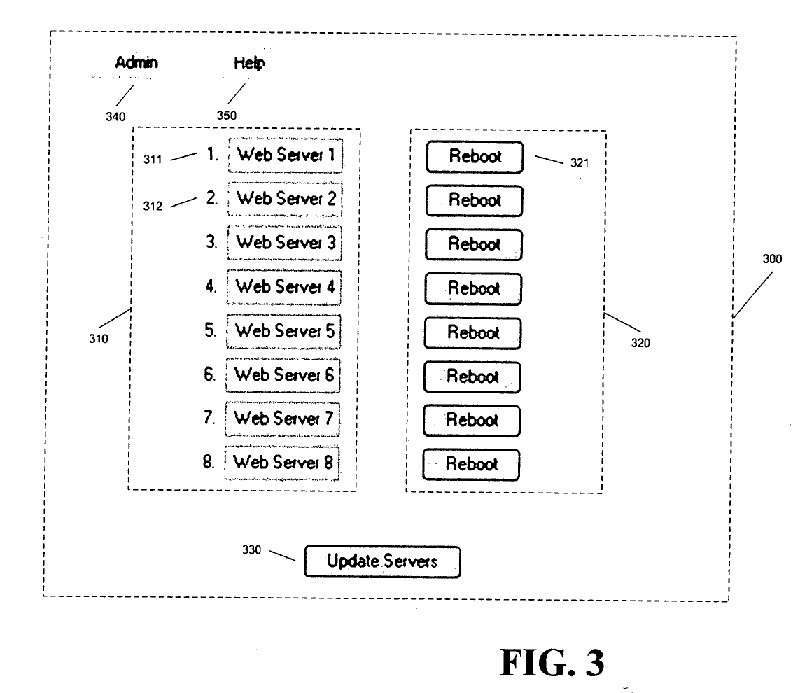

Once the user is properly logged into the device 112, the authorized user may perform administrative services 240 or may reset specific servers 250. The secure connection may be timed and terminated after a short duration. Since no actions relating to the remote reboot device require significant time, a short duration secure connection, such as two minutes, will help limit unauthorized use and outside interference with the computer systems. FIG. 3 illustrates a user interface 300 operable within the SSL session. The user interface 300 is provided as part of the session by the remote reboot device. The user interface 300 identifies the servers 310 connected to the remote reboot device 112. Each server 311, 312 is listed by name. The user may change the names in the list within the administrative services area. Thus, server names used within a network can be included in the interface 300. Associated with each server name 311, 312 is a reboot button 321. The set of reboot buttons 320 represent links for performing a reboot operation for a specific server. If a user clicks on a reboot button, the server system 113 identifies and operates the reset module associated with that server and reboot button.

In addition to selectively rebooting any of the servers connected to the remote reboot device, the user can select “ADMIN” 340 to go to the administrative services portion of the system, “HELP” 350 for assistance in operating the system, or “UPDATE SERVERS” 330 for changing the names associated with servers. Users may be provided with different permissions so that all of the options are not necessarily available to each user. Administrative services are used to change the network address of the remote reboot device and to set or change user IDs, passwords, and permissions.

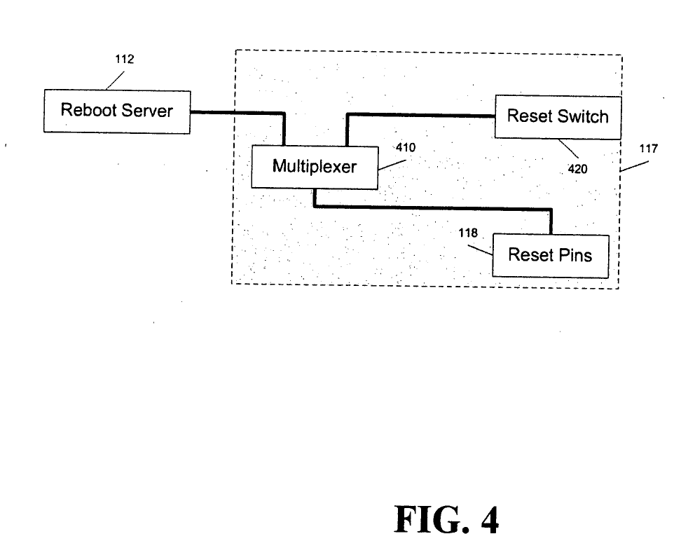

In computer systems having a reset switch, the reset switch is connected to the reset pins on the computer system logic board. With the present invention, a reset module of the remote reboot device must be connected to the reset pins. This can be accomplished by disconnecting the reset switch. In some instances, it may be useful to keep the reset switch operable. If an operator is present in the room housing the computer systems 117 when a reset is required, it would be inconvenient to use the remote reboot device to reset the computer. The reset switch could be used more effectively. FIG. 4 illustrates connection of the remote reboot device 112 to the reset pins 118 in a manner which allows continued operation of the reset switch 420. A multiplexer 410 is used to connect wiring from the reset switch 420 and a reset module of the remote reset device 112 to the reset pins. Preferably, the multiplexer 410 would be housed in the computer system 117. According to an embodiment of the invention, the multiplexer is attached to a PCI board connector. A PCI board is not required, but the PCI board connector attaches to the chassis of the computer system 117. The circuitry of the multiplexer 410 is such that operation of either of the reset switch 420 and the remote reboot device 112 causes the reset pins to be shorted and a reboot to occur.

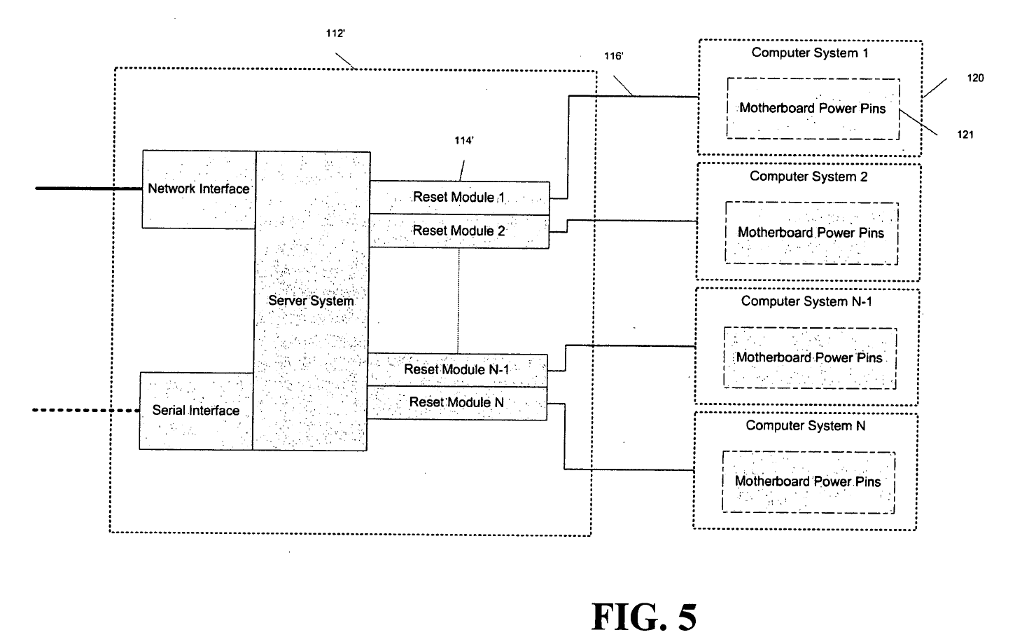

Some computer systems do not have reset pins. With such computer systems, the reboot device according to the embodiment described above cannot be connected to the computer system in order to effectuate a reboot. A second embodiment of the reboot device can be used with such computer systems. All computer systems, whether or not they have reset pins, include power pins on the motherboard or logic board. The power pins are connected to the power switch of the computer system. The power pins are used to disconnect the power to the computer system in order to turn it off or on. If reset pins do not exist on the computer system, the power pins can be used to perform a reboot. A system for rebooting a computer system using the power pins is illustrated in FIG. 5. The wires 116′ from the reset module 114′ of the reboot device 112′ are connected to the computer systems 117′. Specifically, the wires 116′ are connected to the power pins 121 of a computer system 120.

In the first embodiment, the reset module 114 shorts the wires, and attached reset pins, in order to reboot the computer system. However, the power pins of a computer system are not operated merely by shorting the pins. The power pins must be shorted for a minimum time, typically five seconds. When the power pins are shorted for the minimum time, the computer system logic board sends a signal to the computer power supply to terminate supply of power to the system. Once the power has been terminated, the power pins must be shorted a second time to restart the computer. The time period for the second shorting may also be shorted from a minimum time, such as 500 milliseconds.

In order to effectuate a reboot sequence, the remote reboot device 112′ must provide appropriate signals to stop and restart the computer system using the power pins. Specifically, when a reboot is requested for a computer system, the wires 116′ are shorted for a specified time. The shorting of the wires 116′ and pins 121 is stopped for a second specified time, so that the computer can shut off. The wires 116′ and pins 121 are shorted for a third specified time period time to restart the computer system. 120. The time first, second and third time periods may be permanently set to times sufficient to operate different computer systems. Alternatively, the remote reboot device 112′ may be programmable such that different values may be set for the time periods. Values may be set for the device as a whole or may be set for individual reset modules. Furthermore, since the remote reboot device 112′ operates according to a stored program, each reset module 114′ may be controlled independently. Thus, some reset modules 114′ may be connected to reset pins and operated according to the first embodiment of the invention and some may be connected to power pins and operated according to the second embodiment. The procedures for communicating with the remote reboot device 112′ in order to request a reboot are essentially the same as for the first embodiment. The user communicates with the remote reboot device 112′ using a client over a network, such as the Internet. After a login and authentication process, an encrypted session is created. The user can perform administrative process or select one or more computer systems to be rebooted.

The second embodiment of the invention is not as safe for the computer system as the first embodiment. However, if the computer system does not have reset pins, this is the only option. It provides the same process as the operator would perform in physically rebooting the computer system when at its location. The process is better than other remote reboot processes which cycle the power to the computer system. Termination of supplied power can create a power surge to the computer system which is dangerous to computer components. Use of the power pins is consistent with the design of the computer system. It also solves the problem of restarting the computer system. As noted above, some computer systems will not start when power is supplied. However, the second embodiment of the remote reboot device operates on the computer system in the same manner as the physical switch to turn it back on.

As with the first embodiment of the invention, when the wires 116′ from the remote reboot device 112′ are connected to the power pins 121 of the computer system 120 the existing physical switch is no longer connected to the power pins. The remote reboot device 112′ must be used to control the computer system. Alternatively, the multiplexer illustrated in FIG. 4 can be used to allow use of both the remote reboot device and physical switch. The remote reboot device and physical switch are both connected to the multiplexer inputs. The multiplexer output is connected to the power pins 121. Thus, the power pins can be shorted by either the remote reboot device 112′ or the physical switch.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A remote reboot device for rebooting at least one computer system wherein the at least one computer system includes a set of pins on a logic board to control operation of the computer system, the remote reboot device comprising:
a secure receiver for receiving an encrypted instruction to reboot the at least one computer system;
at least one reset module connected to the secure receiver outputting a signal upon receipt of the encrypted instruction; and
at least one wire connecting an output of the at least one reset module to the set of pins on the logic board of the computer system.

2. The remote reboot device according to claim 1, wherein:
the set of pins includes a pair of pins;
the at least one wire includes two wires, one wire connected to each of the reset pins; and
the signal includes shorting the two wires for a first predetermined time.

3. The remote reboot device according to claim 2, wherein the pair of pins includes reset pins.

4. The remote reboot device according to claim 2, wherein the pair of pins includes power pins.

5. The remote reboot device according to claim 4, wherein the signal includes:
removing the shorting of the wires for a second predetermined time; and
shorting the wires for a third predetermined time.

6. The remote reboot device according to claim 5, wherein the first predetermined time is approximately five seconds.

7. The remote reboot device according to claim 1, wherein the secure receiver is connected to a network and the encrypted instruction is received from another device on the network.

8. The remote reboot device according to claim 7 wherein the encrypted instruction is received as part of a secure socket layer session.

9. The remote reboot device according to claim 8 wherein the secure receiver includes means for establishing a secure socket layer session.

10. The remote reboot device according to claim 7, wherein the encrypted instruction is received as part of a secure shell.

11. The remote reboot device according to claim 7, wherein the encrypted instruction is received as an encrypted email.

12. The remote reboot device according to claim 1 wherein:
the at least one computer system includes a plurality of computer systems each having a set of pins on a logic board;
the encrypted instruction includes a designation of one of the plurality of computer systems;
the at least one reset module includes a plurality of reset modules, each of the reset modules having an output connected by at least one wire to a set of pins on a corresponding one of the plurality of computer systems, and each of the reset modules outputting a signal upon receipt of an encrypted instruction designating a computer system corresponding to the reset module.

13. The remote reboot device according to claim 12, wherein at least one of the reset modules outputs a signal of a first signal type, and at least another one of the reset modules outputs a signal of a second signal type different from the first signal type.

14. The remote reboot device according to claim 13, wherein:
the first signal type includes shorting corresponding wires for a first predetermined time; and
the second signal type includes shorting corresponding wires for a second predetermined time, removing the short of the corresponding wires for a third predetermined time, and shorting the corresponding wires for a fourth predetermined time.

15. The remote reboot device according to claim 1 wherein the at least one wire includes:
a multiplexer having a first input connected to a switch of the computer system;
at least one first wire connecting an output of the reset module to a second input of the multiplexer; and
at least one second wire connecting an output of the multiplexer to the set of pins of the computer system.

16. A method for remotely rebooting at least one computer system, the at least one computer system including a set of pins on a logic board to control operation of the computer system, the method comprising the steps of:
receiving an encrypted instruction to reboot the at least one computer system; and
applying a signal to the set of pins of the at least one computer system upon receipt of the encrypted instruction to reboot the computer system.

17. The method of claim 16, wherein the set of pins includes reset pins and wherein the step of applying a signal includes shorting the reset pins.

18. The method of claim 16, wherein the set of pins includes power pins and wherein the step of applying a signal includes the steps of:
shorting the power pins for a first predetermined time;
removing the shorting of the power pins for a second predetermined time; and
shorting the pins for a third predetermined time.

19. The method of claim 18, wherein the first predetermined time is approximately five seconds.

20. The method of claim 16, wherein the at least one computer system includes a plurality of computer systems, and
wherein the step of receiving an encrypted instruction includes the step of receiving an encrypted instruction to reboot a designated one of the plurality of computer systems; and
wherein the step of applying a signal includes the step of applying a signal to the set of pins of the designated one of the plurality of computer systems.

21. The method of claim 20, further comprising the step of associating each of the plurality of computer systems with a signal type; and
wherein the step of applying a signal includes the steps of:
determining a signal type of associated with the designated one of the plurality of computer systems; and
applying a signal of a signal type to the set of pins of the designated on of the plurality of computer systems.

22. The method of claim 21, wherein the signal types include:
a first signal type in which the set of pins are shorted for a predetermined time; and
a second signal type in which the set of pins are shorted for a first predetermined time, the short is removed for a second predetermined time, and the set of pins is shorted for a third predetermined time.

23. The method of claim 16, wherein the receiving step includes receiving an encrypted instruction from a network.

24. The method of claim 23, wherein the receiving step includes receiving an encrypted email.

25. The method of claim 23, wherein the receiving step includes the steps of:
establishing a secure socket layer session; and
receiving login information;
receiving the encrypted instruction as a part of the secure socket layer session.

26. The method of claim 23, wherein the receiving step includes the step of establishing a secure shell session.
